(19) United States
(12) Patent Application Publication
(10) Pub. No.: US 2026/0200183 A1
(43) Pub. Date: Jul. 16, 2026

(54) SYSTEMS AND METHODS FOR MITIGATING INTERNAL THERMAL STRESSES IN THERMOPLASTIC COMPOSITE LAYUPS

(71) Applicant: Wichita State University, Wichita, KS (US)

(72) Inventors: Waruna Seneviratne, Wichita, KS (US); Joshua Goertz, Wichita, KS (US)

(21) Appl. No.: 19/448,683

(22) Filed: Jan. 14, 2026

Related U.S. Application Data
(60) Provisional application No. 63/744,956, filed on Jan. 14, 2025.

(51) Int. Cl. B29C 70/38; B29K 101/12; B29K 105/10

(52) U.S. Cl. CPC B29C 70/384; B29K 2101/12; B29K 2105/108

(57) ABSTRACT

A method of constructing a composite article having a first surface and a second surface is provided. Composite material is deposited with an automated fiber placement (AFP) robot to form at least one ply of the composite article. The composite article is flipped over in relation to the AFP robot from a first orientation in which the first surface of the composite article faces the AFP robot to a second orientation in which the second surface of the composite article faces the AFP robot. At least one new ply is deposited onto the composite article in the second orientation using the AFP robot. The composite article can the bee flipped back over to the first orientation and the preceding steps may be repeated until the composite article is formed.

### CROSS-REFERENCE TO RELATED APPLICATIONS

This application claims priority to U.S. Provisional Patent Application No. 63/744,956, titled SYSTEMS AND METHODS FOR MITIGATING INTERNAL THERMAL STRESSES IN THERMOPLASTIC COMPOSITE LAYUPS, filed January 14, 2025, which is hereby incorporated by reference in its entirety.

### BACKGROUND

Thermoplastic (TP) composites are materials widely used across various industries, including aerospace, automotive, construction, marine, wind energy, and concrete reinforcement. TP composites are gaining popularity due to their superior toughness, fast processing cycle times, and recyclability. Unlike thermoset composites, thermoplastics can be remelted and reshaped, allowing for easier recycling and repair. The rapid cycle times associated with TP composites lead to increased production efficiency, making them particularly attractive for high-volume applications.

Automated Fiber Placement (AFP) technology has emerged as leader in composites manufacturing, especially in the aerospace industry. AFP enables the precise laying down of composite tape in multiple layers (plies) to form a composite part.

Despite these advantages, the production of thermoplastic composite parts face challenges, particularly warping. This issue becomes more pronounced as the size and number of plies increases. Warping occurs due to the internal stresses that develop when very hot composite material is deposited onto cooler layers of material. The difference in temperatures causes uneven cooling and thermal expansion, leading to internal stresses that can warp the final part. Once this stress builds to a sufficient degree, the layup will curl and pull off the surface of tool. As the thickness of the panel increases, the warpage may become so severe, that the AFP process must be stopped. The part may then be scrapped because it is too warped to be effectively post-processed in an oven, autoclave, or heated press.

### SUMMARY

According to an aspect of the present disclosure, a method of constructing a composite article having a first surface and a second surface is provided. The method comprises depositing a composite material with an automated fiber placement (AFP) robot to form at least one ply of the composite article. The method further comprises flipping the composite article over in relation to the AFP robot from a first orientation in which the first surface of the composite article faces the AFP robot to a second orientation in which the second surface of the composite article faces the AFP robot. The method further comprises depositing at least one new ply onto the composite article in the second orientation using the AFP robot.

According to other aspects of the present disclosure, the method may include one or more of the following features. The method may further comprise flipping the composite article back over to the first orientation and depositing at least one new ply onto the composite article in the first orientation using the AFP robot. Depositing the composite material with the AFP robot may form a first ply within a ply sequence of a completed composite article, wherein the first ply is a center ply. The ply sequence of the completed composite article may comprise a plurality of plies, each ply having a fiber orientation, the fiber orientations of the plies having symmetry on opposite sides of a center plane of the ply sequence. The method may further comprise depositing a second ply, a third ply, and a fourth ply on a first side of the center ply. The method may further comprise depositing an opposing center ply, an opposing second ply, an opposing third ply, and an opposing fourth ply on a second side of the center ply. The method may further comprise depositing the at least one ply in a three-dimensional space with the AFP robot and providing an opposing force with a dynamic support robot to shape the composite material. The composite material may be a thermoplastic composite material. Depositing the composite material may comprise forming adjacent base plies from strips arranged parallel to one another in staggered, overlapped relation, wherein each strip in a base ply overlaps at least one strip in an adjacent base ply along a portion of the width of the strips.

According to another aspect of the present disclosure, a system for constructing a composite article is provided. The system comprises an Automated Fiber Placement (AFP) robot, the AFP robot configured to deposit strips of composite material to form the composite article. The system further comprises a dynamic support robot opposite the AFP robot, the dynamic support robot configured to track the AFP robot in space so that, as the AFP robot moves to deposit the strips of composite material, the dynamic support robot continuously positions itself to provide, uninterrupted, a support surface against which the AFP robot presses the strips of composite material. The system further comprises a reference frame defining a forming space configured to support end portions of the deposited strips of composite material such that the composite article is formed in the forming space. The reference frame is rotatable about an axis of rotation in relation to the AFP robot between a first position in which the reference frame is positioned to hold the composite article so that a first surface of the composite article faces the AFP robot and a second position in which the reference frame is positioned to hold the composite article so that a second surface of the composite article faces the AFP robot.

According to other aspects of the present disclosure, the system may include one or more of the following features. The system may further comprise a controller communicatively coupled to the AFP robot, wherein the controller is configured to instruct the AFP robot to deposit one or more plies on the reference frame to form a first portion of the composite article while the reference frame is in the first position and to instruct the AFP robot to deposit one or more additional plies on the reference frame to form another portion of the composite article while the reference frame is in the second position. The system may further comprise an actuator for driving rotation of the reference frame between the first position and the second position, the controller being communicatively coupled to the actuator for selectively flipping the composite article by rotating the reference frame from the first position to the second position and from the second position to the first position. The controller may be further communicatively coupled to the dynamic support robot, the controller being configured to synchronize movements of the AFP robot and the dynamic support robot such that the dynamic support robot tracks the AFP robot during deposition of the strips of composite material. The system may be devoid of any stationary tool against which the strips of composite material are laid. The reference frame may comprise a plurality of support members to which end portions of the strips of composite material are attached. The AFP robot may be configured to deposit multiple strips simultaneously. The composite material may be a thermoplastic composite material. The reference frame may be rotatable about the axis of rotation by approximately 180 degrees between the first position and the second position. The AFP robot may be configured to deposit strips of composite material to form adjacent base plies arranged parallel to one another in staggered, overlapped relation. The controller may be configured to instruct the AFP robot to deposit a center ply of the composite article prior to depositing additional plies on opposite sides of the center ply.

Other aspects and features will be apparent hereinafter.

### BRIEF DESCRIPTION OF DRAWINGS

FIG. 1 depicts a tool-less system for forming a composite article, according to aspects of the present disclosure.

FIG. 2 depicts the tool-less system of FIG. 1 with a reference frame in a rotated position, according to aspects of the present disclosure.

FIG. 3 depicts a system for forming a composite article with a tool in a first orientation, according to an embodiment.

FIG. 4 depicts the system of FIG. 3 with a composite article being flipped to a second orientation, according to an embodiment.

FIG. 5 depicts the system of FIG. 3 with the composite article in the second orientation, according to an embodiment.

FIG. 6 depicts a perspective view of a composite article having a contoured geometry, according to aspects of the present disclosure.

FIG. 7 depicts a cross-sectional diagram of a composite laminate showing fiber orientations, according to aspects of the present disclosure.

FIG. 8 depicts a ply table describing fiber orientations of a composite article, according to aspects of the present disclosure.

Reference numerals in the drawings correspond to like elements in the detailed description. Such reference numerals are used to facilitate an understanding of the disclosure and are not intended to be limiting.

### DETAILED DESCRIPTION

This disclosure presents systems and methods for constructing thermoplastic composite articles from the mid-plane outward, mitigating internal thermal stresses caused by significant thermal gradients during heated TP composite material layup. This approach reduces warping, especially when the fiber direction is the same in every ply. The layup process starts at a center ply of a laminate. Initially at least one ply or multiple plies may be deposited with an AFP machine. The deposited plies may then be flipped over, or rotated 180 degrees, such that the plies that were closest in proximity to the AFP head are now on the opposite side. In other words, what was once the back surface, has now become the front surface which is closest to the AFP head. Then at least one new ply, possibly more than one ply, may be applied to front side of the layup. After those plies have been applied, the layup may be flipped once again, and more plies may be deposited. This rotation sequence may be repeated multiple times until the composite article is completed. Alternating the deposition of material reduces warpage of the composite article, which may be further improved by tailoring the sequence to deposit multiple plies with certain fiber orientations that balance the layup as it is being built. Essentially, this is a way of balancing the laminate during the layup in a way that has never been previously possible with traditional layup techniques where a laminate must be built from one side of the laminate to another. This in-process balancing reduces internal stress buildup and results in lower warpage composite articles.

In one implementation, the TP composite article is constructed on a substantially flat tool, with plies being flipped and repositioned on the tool for subsequent ply deposition. In another implementation, the laminate is constructed with a tool-less AFP system where two robots are used to create in-situ consolidated TP composite parts having a contoured geometry. In the tool-less AFP system, one robot deposits material while the second robot applies an opposing force to support the material while it cools. The TP composite material is suspended in a reference frame. This system enables laminate construction from the mid-plane outward in a symmetric manner by rotating the reference frame, allowing AFP robotic access to both sides of the layup.

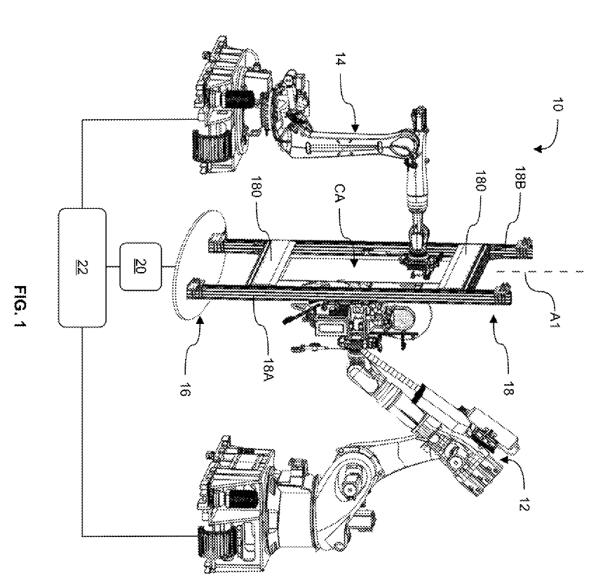

Turning to FIG. 1, an exemplary tool-less system for forming a composite article CA (e.g., a TP composite article) is shown schematically at reference number 10. The tool-less system 10 broadly comprises an AFP robot 12, a dynamic support robot 14, and a rotatable fixture 16. The rotatable fixture 16 includes a reference frame 18 including a plurality of frame edges surrounding an open forming space in which the reference frame 18 is configured to suspend the composite article CA as it is formed. That is, the AFP robot 12 is configured to lay up plies that extend across the reference frame 18 from one side to another. Where the plies extend across the opening in the reference frame 18, they are not supported or laid against a stationary tool. The system 10, in other words, is devoid of any stationary tool against which AFP plies are laid.

The AFP robot 12 is configured to deposit composite material (e.g., TP composite material) in a plurality of strips or "tape." The dynamic support robot 14 is equipped with a head that is configured to provide an opposing force to the AFP robot 12 to form the plurality of strips in three-dimensional space. Multi-robot systems comprising a first, AFP robot and a second, dynamic support robot that acts in place of a tool to support the AFP material opposite the AFP robot as it is laid down are commercially available from Mikrosam, a company based in Prilep, Macedonia.

The rotatable fixture 16 includes the reference frame 18, where the composite strips span the open space between the sides of the reference frame 18. The ends of AFP strips are tacked or otherwise attached to the reference frame 18. In the illustrated embodiment, the reference frame 18 includes two support members 180 to which the composite strips are attached to support the composite article CA on the reference frame 18. The reference frame 18 comprises a first leg 18A on one side of the support members 180 and the composite article CA and a second leg 18B on an opposite side of the support members and the composite article. In other embodiments, the strips may be attached to more than two support members. Further, frames of any suitable two- or three-dimensional shape can be used without departing from the scope of the disclosure.

The rotatable fixture 16 further comprises an actuator 20 configured to rotate the reference frame 18 about an axis A1. The illustrated system 10 further includes a controller 22 communicatively coupled to the actuator 20, the AFP robot 12, and the dynamic support robot 14. The controller 22 is configured to selectively control the actuator 20 for rotating the reference frame 18. The controller 22 may also control the movements of both the AFP robot 12 and the dynamic support robot 14. The controller 22 can comprise separate, communicatively linked controllers to synchronize robot movements and coordinate support fixture rotation.

The AFP robot 12 is suitably configured for depositing multiple strips simultaneously, such as 4, 8, 16, 24 or 32 strips per course. Multiple courses may be laid down across the reference frame 18 to form a complete layer, referred to as a ply. As the plies are laid down, the composite article CA is constructed to have a first surface and a second surface opposite the first surface. The reference frame 18 is rotatable about the axis A1 to a first position and a second position. In the first position, the first surface of the composite article CA faces the AFP robot 12 and the second surface faces away from the AFP robot 12 toward the dynamic support robot 14. In the second position, the second surface of the composite article CA faces the AFP robot 12 and the first surface faces away from the AFP robot 12 toward the dynamic support robot 14. Thus, when the reference frame 18 is in the first position, the system 10 is configured for laying new plies on the first surface of the composite article CA, and when the reference frame 18 is rotated to the second position, the system 10 is configured for laying new plies on the second surface of the composite article CA. The system 10 can be configured to prevent the AFP robot 12 from ever laying up plies or strips on whichever surface of the composite article CA faces away from the AFP robot 12 and toward the dynamic support robot 14.

The system 10 is broadly configured to construct a composite article CA by (i) forming one or more plies while the reference frame 18 is in the first position, (ii) rotating the reference frame 18 to the second position, and (iii) forming one or more plies while the reference frame 18 is in the second position. After performing steps (i)-(iii), the system 10 will typically rotate the reference frame 18 back to the first position and repeat steps (i)-(iii). These steps are repeated until the entire composite article CA has been constructed on the reference frame 18 (without a tool). It will be understood that the last ply for the composite article CA can be laid with the reference frame 18 in either the first or second position, depending on the specifications for the composite article CA.

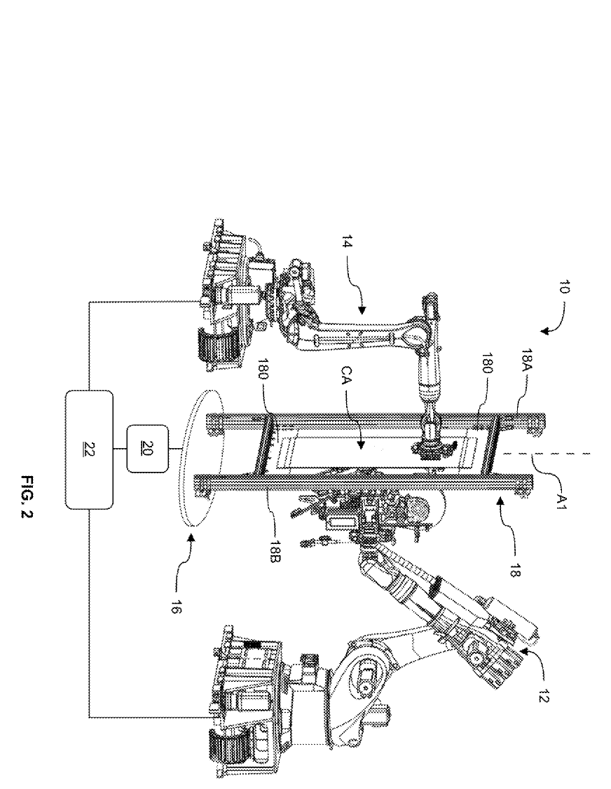

A sequence of ply layup and flipping is shown in FIGS. 1 and 2 in order to illustrate the process. In FIG. 2, a single ply made up of courses of tapes is deposited by the AFP robot 12. The ply is suspended on the reference frame 18 of the rotatable fixture 16. The ply shown in FIG. 1 is the first ply formed for the composite article CA. Based on the above-described process, the person skilled in the art will recognize that this first ply can form a center ply of the composite article CA using the system 10 and methods of the present disclosure. This is in distinct contrast from conventional composite manufacturing processes where the first ply is formed against a tool and thus ultimately defines an inner or outer surface of the part.

During the first ply formation step, contours can be formed without a stationary tool by the synchronizing the movement of the AFP robot 12 with the dynamic support robot 14. That is, the dynamic support robot 14 tracks the AFP robot 12 in space so that, as the AFP robot 12 moves to lay down strips of AFP material, the dynamic support robot 14 continuously positions itself to provide, uninterrupted, a support surface against which the AFP robot 12 presses.

If desired, after the first ply is formed, the AFP robot 12 can form one or more additional plies on the first side of the composite article CA before the controller 22 actuates the actuator 20 to rotate the reference frame 18. (It will be understood that rotation of the reference frame 18 between the first and second positions can also be conducted manually in some embodiments). For example, the AFP robot 12 can lay additional courses onto the first surface of the composite article CA, where one or more of the courses are laid at a different fiber direction than the courses of the first ply. In one example, the fiber direction in the second ply is oriented at a 45-degree angle to the fiber direction of the first ply.

As shown in FIG. 2, once the desired number of plies have been laid on the first side of the composite article CA, the actuator 20 rotates the reference frame 18 about the axis A1 180-degrees to the second position (such that the second surface of the composite article CA faces the AFP robot 12 and the first surface faces away from the AFP robot 12 toward the dynamic support robot 14). It is evident from the position of the legs 18A, 18B in FIG. 2 that the frame 18 and the composite article CA has been reversed relative to FIG. 1 about the axis A1. Once the reference frame 18 has been rotated to the second position, the AFP robot 12 lays one or more additional plies to the second surface of the composite article CA. As explained above, the process can comprise multiple layup and rotation cycles repeated until the final composite article CA is achieved.

The completed composite article CA may have any number of plies. For example, the completed composite article CA may have between 4 and 50 plies, it is possible the final laminate may have greater than 50 plies, even 150 plies.

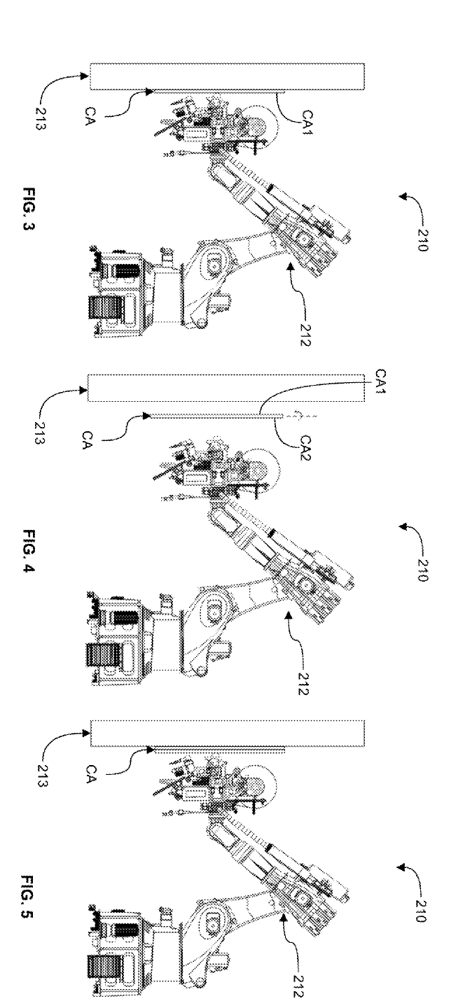

Referring now to FIG. 3, a system for forming a composite article CA in accordance with the present disclosure is generally indicated at reference number 210. The system 210 is a tool-based system for forming a composite article, in contrast to the tool-less system 10 described above. The system 210 comprises an AFP robot 212 and a tool 213. The tool 213 is substantially flat, which will yield a substantially flat composite article CA. In FIG. 3, the composite article CA is in a first orientation in which a first side CA1 of the composite article CA faces the AFP robot 212. As shown in FIG. 4, after forming the plies in the first orientation, the composite article CA is flipped over to a second orientation in which the first side CA1 of the composite article CA faces the tool 213 and a second side CA2 faces the AFP robot 212. In FIG. 5, a new ply is deposited onto the composite article CA in the second orientation.

Accordingly, similar to the tool-less system 10 above, the tool-based system 210 is used to make a composite article CA by: (i) forming one or more plies while the composite article CA is in the first orientation, (ii) flipping the composite article CA over to the second orientation, and (iii) forming one or more plies while the composite article CA is in the second orientation. After the first cycle of steps (i)-(iii), the process will typically involve flipping the composite article CA back to the first orientation and repeating steps (i)-(iii) one or more additional times. Again, the process ends when the last ply for the composite article CA is laid on either the first side CA1 or the second side CA2 of the composite article CA, depending on the specifications for the composite article CA. As with the tool-less process described above, the tool-based process yields a completed composite article CA formed so that the first-laid plies are near the center of the composite article CA, rather than along an exposed surface of the composite article CA.

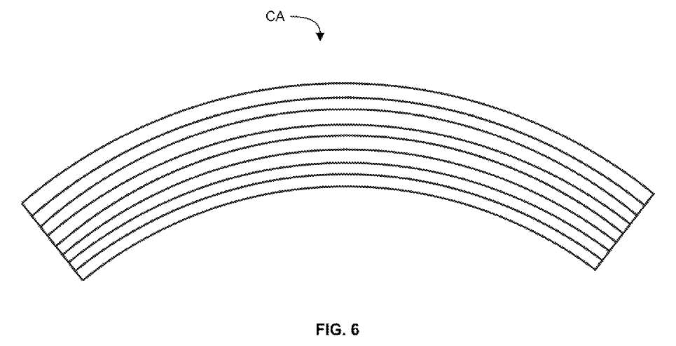

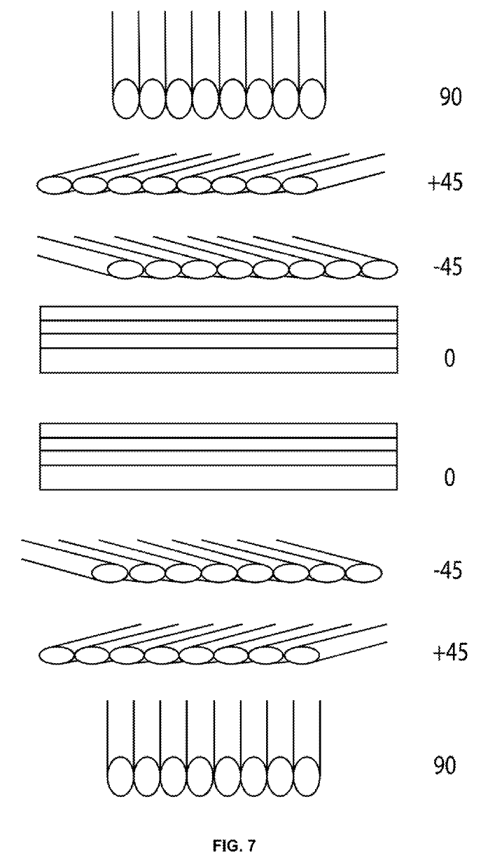

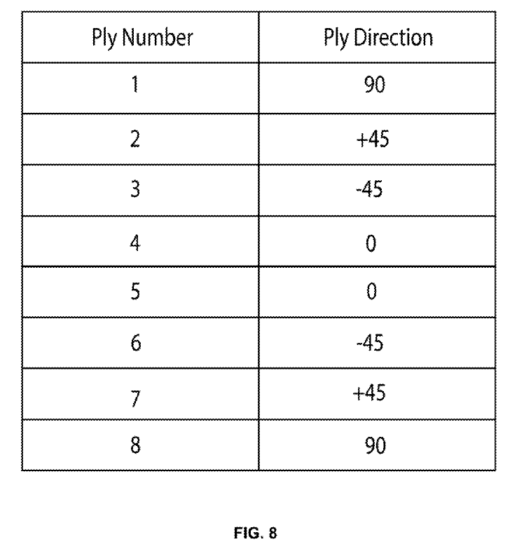

FIG. 6 illustrates a completed composite article CA with a contoured geometry, which may be made by the tool-less AFP system 10 described above. In the example shown in FIG. 6, the final composite article CA comprises 8 plies. FIG. 7 shows one example of the fiber orientations of each ply within the final composite article CA. FIG. 8 is a ply table describing the fiber orientations of the eight-ply composite article CA depicted in FIGS. 6 and 7. The laminate stack has fiber orientation symmetry on opposite sides of its center plane (between plies 4 and 5). In the illustrated example, there are two centermost plies with the same fiber orientation, 0 degrees in this case. The orientations of the remaining plies are mirrored on opposite sides of the centermost plies, resulting in a symmetrical laminate with an equal number of plies in each orientation.

To construct the composite article CA using the disclosed method, one possible layup sequence is as follows: (1) Initially deposit the two 0 degree central plies and one -45 degree ply using the AFP robot. (2) Rotate the layup 180 degrees about the horizontal axis and apply the opposing -45 degree ply. (3) Deposit a 45 degree ply followed by a 0 degree ply. (4) Rotate the laminate again and apply the final 45 degree and 0 degree plies. While this sequence demonstrates one potential application of the flipping and depositing method, various other combinations of depositing, flipping and ply sequences may be employed to achieve the desired composite article CA. Furthermore, the disclosed methods are not limited to balanced and symmetrical laminates; they can also be utilized to construct non-balanced and unsymmetrical laminates.

In another implementation, the construction of a 24-ply laminate proceeds as follows: The process may begin with the deposition of ply 13, which serves as the central ply of the final stack of plies within the completed composite article CA. Subsequently, plies 14, 15, and 16 are sequentially laid up. Upon completion of this initial sequence, the operator removes the partially constructed panel from the layup tool and rotates it 180 degrees around its horizontal axis. The panel is then secured back onto the layup tool, presenting the previously tool-side surface to the AFP head. Subsequently, plies 12, 11, 10, and 9 are deposited onto the newly exposed surface. This process of flipping and depositing continues on alternating sides until the composite article CA is completely constructed. The number of plies deposited between each flip is variable and can be optimized based on the ply sequence, thermal considerations, and laminate size and geometry. While the example provided details of a specific sequence for a 24-ply laminate, it should be understood that the method is applicable to laminates of varying ply counts.

In an example, the tool-less AFP system 10 may from adjacent base plies formed from strips that are arranged parallel to one another in staggered, overlapped relation. The base plies are used to establish the three-dimensional geometry of the composite article CA and are formed to prevent sagging during the subsequent processing steps. In one example, each strip in a base ply overlaps at least one strip in the adjacent base ply along portions of the width of the two strips (e.g., at least 10% of the width of each strip, at least 20% of the width of each strip, at least 30% of the width of each strip, at least 40% of the width of each strip, at least 50% of the width of each strip; and/or less than 90% of the width of each strip, less than 80% of the width of each strip, less than 70% of the width of each strip, less than 60% of the width of each strip). This staggering of the courses of material in the base plies provides a stronger foundation for the subsequent addition of plies.

To further elaborate on this example, an 8-ply composite article CA with the following ply sequence could be constructed such that the center plies have a staggered overlap. The first ply deposited by the AFP robot may be the 4th ply in the ply sequence deposited at a 0-degree orientation. Then the second ply deposited may be the 5th ply in the ply sequence, also 0 degrees in orientation. The second center ply may overlap the first ply by ½ of the strip width, effectively staggering the plies. From there a 45-degree ply could be deposited before flipping the reference frame 18 and then depositing a new 45-degree ply on the opposite side. The deposition and flipping process continues until the laminate is complete. It should be noted that the numbering of the ply sequence is sequential in the ply sequence table as shown in FIG. 9, however the layup sequence of the AFP machine is non-sequential since the center plies may be built first. From an AFP layup programming perspective, the first and second plies may be the center plies of the completed laminate.

The systems and methods disclosed herein provide may have advantages over conventional composite manufacturing approaches. By constructing the composite article from the mid-plane outward, internal thermal stresses that develop during heated thermoplastic composite material layup may be reduced or balanced as the laminate is built. This in-process balancing may result in lower warpage composite articles compared to traditional layup techniques where a laminate is built from one side to another. The ability to access both sides of the layup during construction allows for greater flexibility in ply sequencing and may enable the production of thicker laminates that would otherwise be prone to excessive warping. In some aspects, the tool-less system configuration permits the formation of contoured composite articles without requiring expensive stationary tooling, which may reduce manufacturing costs and increase design flexibility. The staggered overlap arrangement of base plies may provide improved structural integrity and resistance to sagging during processing. These approaches may be particularly beneficial for aerospace, automotive, and other applications where dimensional accuracy and reduced residual stresses in composite parts are desired.

When introducing elements of the present disclosure or the preferred embodiment(s) thereof, the articles "a", "an", "the" and "said" are intended to mean that there are one or more of the elements. The terms "comprising", "including" and "having" are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of constructing a composite article having a first surface and a second surface, the method comprising:
depositing a composite material with an automated fiber placement (AFP) robot to form at least one ply of the composite article;
flipping the composite article over in relation to the AFP robot from a first orientation in which the first surface of the composite article faces the AFP robot to a second orientation in which the second surface of the composite article faces the AFP robot; and
depositing at least one new ply onto the composite article in the second orientation using the AFP robot.

2. The method of claim 1, further comprising flipping the composite article back over to the first orientation and depositing at least one new ply onto the composite article in the first orientation using the AFP robot.

3. The method of claim 1, wherein depositing the composite material with the AFP robot forms a first ply within a ply sequence of a completed composite article, wherein the first ply is a center ply.

4. The method of claim 3, wherein the ply sequence of the completed composite article comprises a plurality of plies, each ply having a fiber orientation, the fiber orientations of the plies having symmetry on opposite sides of a center plane of the ply sequence.

5. The method of claim 3, further comprising depositing a second ply, a third ply, and a fourth ply on a first side of the center ply.

6. The method of claim 5, further comprising depositing an opposing center ply, an opposing second ply, an opposing third ply, and an opposing fourth ply on a second side of the center ply.

7. The method of claim 1, further comprising depositing the at least one ply in a three-dimensional space with the AFP robot and providing an opposing force with a dynamic support robot to shape the composite material.

8. The method of claim 1, wherein the composite material is a thermoplastic composite material.

9. The method of claim 1, wherein depositing the composite material comprises forming adjacent base plies from strips arranged parallel to one another in staggered, overlapped relation, wherein each strip in a base ply overlaps at least one strip in an adjacent base ply along a portion of the width of the strips.

10. A system for constructing a composite article, the system comprising:
an Automated Fiber Placement (AFP) robot, the AFP robot configured to deposit strips of composite material to form the composite article;
a dynamic support robot opposite the AFP robot, the dynamic support robot configured to track the AFP robot in space so that, as the AFP robot moves to deposit the strips of composite material, the dynamic support robot continuously positions itself to provide, uninterrupted, a support surface against which the AFP robot presses the strips of composite material;
a reference frame defining a forming space configured to support end portions of the deposited strips of composite material such that the composite article is formed in the forming space, the reference frame being rotatable about an axis of rotation in relation to the AFP robot between a first position in which the reference frame is positioned to hold the composite article so that a first surface of the composite article faces the AFP robot and a second position in which the reference frame is positioned to hold the composite article so that a second surface of the composite article faces the AFP robot.

11. The system of claim 10, further comprising a controller communicatively coupled to the AFP robot, wherein the controller is configured to instruct the AFP robot to deposit one or more plies on the reference frame to form a first portion of the composite article while the reference frame is in the first position and to instruct the AFP robot to deposit one or more additional plies on the reference frame to form another portion of the composite article while the reference frame is in the second position.

12. The system of claim 11, further comprising an actuator for driving rotation of the reference frame between the first position and the second position, the controller being communicatively coupled to the actuator for selectively flipping the composite article by rotating the reference frame from the first position to the second position and from the second position to the first position.

13. The system of claim 10, wherein the controller is further communicatively coupled to the dynamic support robot, the controller being configured to synchronize movements of the AFP robot and the dynamic support robot such that the dynamic support robot tracks the AFP robot during deposition of the strips of composite material.

14. The system of claim 10, wherein the system is devoid of any stationary tool against which the strips of composite material are laid.

15. The system of claim 10, wherein the reference frame comprises a plurality of support members to which end portions of the strips of composite material are attached.

16. The system of claim 10, wherein the AFP robot is configured to deposit multiple strips simultaneously.

17. The system of claim 10, wherein the composite material is a thermoplastic composite material.

18. The system of claim 10, wherein the reference frame is rotatable about the axis of rotation by approximately 180 degrees between the first position and the second position.

19. The system of claim 10, wherein the AFP robot is configured to deposit strips of composite material to form adjacent base plies arranged parallel to one another in staggered, overlapped relation.

20. The system of claim 10, wherein the controller is configured to instruct the AFP robot to deposit a center ply of the composite article prior to depositing additional plies on opposite sides of the center ply.
